(19) United States
(12) Patent Application Publication
(10) Pub. No.: US 2004/0193970 A1
(43) Pub. Date: Sep. 30, 2004

(54) Receiver system with adjustable sampling and reference levels

(76) Inventors: Casper Dietrich, Roskilde (DK); Steen B. Christensen, Roskilde (DK)

Correspondence Address: Glen B. Choi, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/404,783

(22) Filed: Mar. 31, 2003

(51) Int. Cl. G11B 5/00; G06K 5/04; G11B 20/20

(52) U.S. Cl. 714/700

(57) ABSTRACT

Briefly, a receiver system that may have an adjustable DC offset cancellation (vertical offset) and horizontal sampling point movement (horizontal offset) capabilities.

### FIELD

The subject matter disclosed herein generally relates to techniques to regenerate signals.

### DESCRIPTION OF RELATED ART

Signals transmitted through a communications system typically experience jitter. Jitter is the general term used to describe distortion caused by variation of a signal from its reference timing position in a communications system. In an ideal system, bits arrive at time increments that are integer multiples of a bit repetition time. In an operational system, however, pulses typically arrive at times that deviate from these integer multiples. This deviation may cause errors in the recovery of data, particularly when data is transmitted at high speeds. The deviation or variation may be in the amplitude, time, frequency or phase of this data. Jitter may be caused by a number of phenomena, including inter-symbol interference, frequency differences between the transmitter and receiver clock, noise, and the non-ideal behavior of the receiver and transmitter clock generation circuits.

Regenerating signals received from the communications system is an important operation. Typically, received signals are sampled and a replica signal is generated using the samples and a receiver reference clock. Accordingly, it is important to properly sample the received signal so that the received signal is accuarately reproduced (i.e., the reproduced signal accuarately represents a signal originally transmitted through the communications system).

An “eye” diagram may represent phase transitions of a signal received from a communication network. In an “open eye” scenario, transitions of the received signal occur substantially within confined phase regions. When transitions of the received signal do not occur within confined phase regions, to more accuarately sample the received signal, a technique known as horizontal offset compensation may be used. Horizontal offset compensation refers to adjusting a sampling phase of the received signal.

An input system of a signal receiver may experience a DC offset at its input terminal(s) that may cause asymmetry among peak voltages of a signal output by such receiver's input system. For example, such input system may include a limiting amplifier. DC offset may lead to inaccurate sampling of the received signal. Vertical (DC) offset cancellation may be used to adjust the voltage at receiver's input system to cancel DC offset and thus allow for more accurate sampling of the received signal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a receiver system that may have an adjustable DC offset cancellation (vertical offset) and horizontal sampling point movement (horizontal offset) capabilities in accordance with an embodiment of the present invention; and

FIG. 2 depicts one possible implementation of an eye adjuster system in accordance with an embodiment of the present invention.

Note that use of the same reference numbers in different figures indicates the same or like elements.

### DETAILED DESCRIPTION

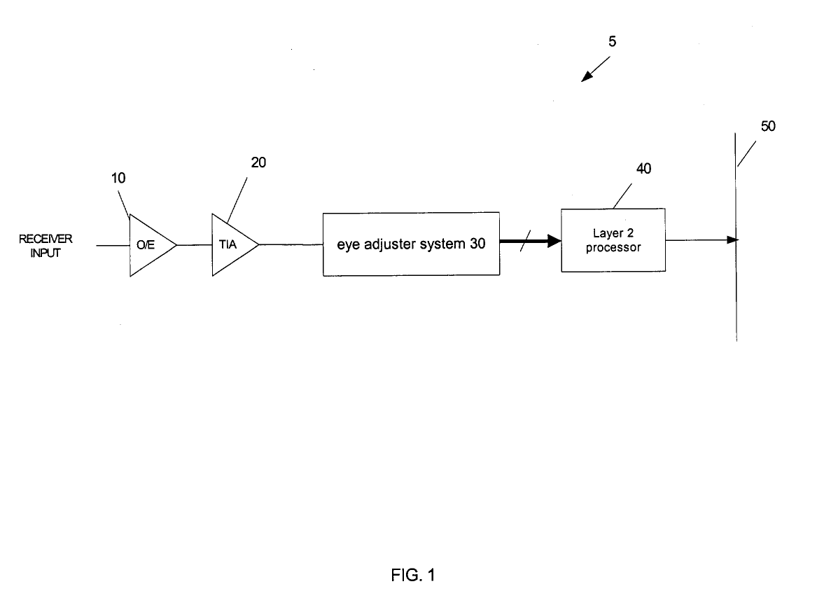

In accordance with an embodiment of the present invention, FIG. 1 depicts a receiver system 5 that may have an adjustable DC offset cancellation (vertical offset) and horizontal sampling point movement (horizontal offset) capabilities. One embodiment of receiver system 5 may include: O/E converter 10, transimpedance amplifier (“TIA”) 20, eye adjuster system 30, layer 2 processor 40, and backplane 50.

O/E converter 10 may convert an optical input signal labeled RECEIVER INPUT from optical to electrical format. For example, O/E converter 10 may receive optical signals encoded in compliance for example with optical transport network (OTN), Synchronous Optical Network (SONET), and/or Synchronous Digital Hierarchy (SDH) standards. Example optical networking standards may be described in ITU-T Recommendation G.709 Interfaces for the optical transport network (OTN) (2001); ANSI T1.105, Synchronous Optical Network (SONET) Basic Description Including Multiplex Structures, Rates, and Formats; Bellcore Generic Requirements, GR-253-CORE, Synchronous Optical Network (SONET) Transport Systems: Common Generic Criteria (A Module of TSGR, FR-440), Issue 1, Dec. 1994; ITU Recommendation G.872, Architecture of Optical Transport Networks, 1999; ITU Recommendation G.825, “Control of Jitter and Wander within Digital Networks Based on SDH” March, 1993; ITU Recommendation G.957, “Optical Interfaces for Equipment and Systems Relating to SDH”, July, 1995; ITU Recommendation G.958, Digital Line Systems based on SDH for use on Optical Fibre Cables, November, 1994; and/or ITU-T Recommendation G.707, Network Node Interface for the Synchronous Digital Hierarchy (SDH) (1996).

TIA 20 may amplify an electrical format input signal. For example, TIA 20 may receive a small input current and convert such current to a small output voltage (e.g., in the order of millivolts). TIA 20 may be implemented as a transimpedance amplifier.

Eye adjuster system 30 may sample the electrical format input signal and provide a reproduction of such input signal. In accordance with an embodiment of the present invention, eye adjuster system 30 may attempt to improve the accuracy of reproductions of the signal RECEIVER INPUT by providing and adjusting both a DC offset cancellation and a horizontal sampling point based on characteristics of the electrical format input signal. In one embodiment, eye adjuster system 30 may perform forward error correction (“FEC”) processing in compliance for example with ITU-T G.975.

With respect to signals provided by eye adjuster system 30 (such as a reproduction of signal RECEIVER INPUT), layer 2 processor 40 may perform non-FEC layer 2 processing such as media access control (MAC) management in compliance for example with Ethernet, described for example in versions of IEEE 802.3 and/ or optical transport network (OTN) de-framing and de-wrapping in compliance for example with ITU-T G.709.

Backplane 50 may provide intercommunication between layer 2 processor and other devices such as a packet processor (not depicted) and/or switch fabric (not depicted).

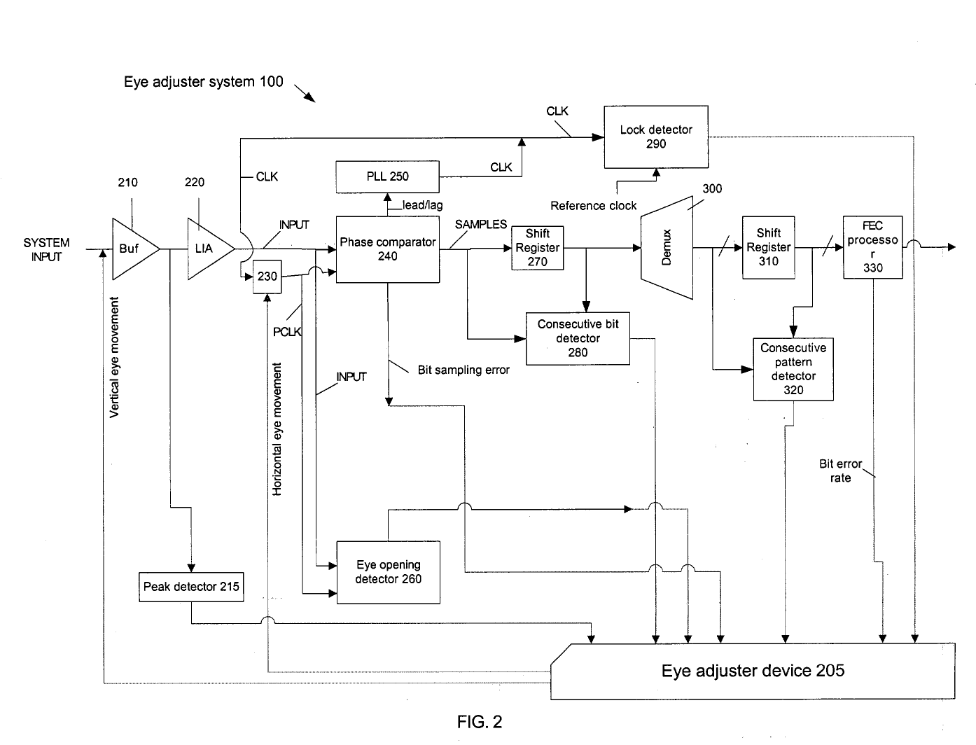

FIG. 2 depicts one possible implementation of an eye adjuster system 100 in accordance with an embodiment of the present invention. Eye adjuster system 100 may include eye adjuster device 205, buffer 210, peak detector 215, limiting amplifier (“LIA”) 220, phase adjuster 230, phase comparator 240, phase locked loop (“PLL”) 250, eye opening detector 260, shift register 270, consecutive bit detector 280, lock detect 290, demux 300, shift register 310, consecutive pattern detector 320, and forward error correction (“FEC”) processor 330.

In one implementation, components of eye adjuster system 100 may be implemented among the same integrated circuit. In another implementation, components of eye adjuster system 100 may be implemented among several integrated circuits that intercommunicate using, for example, a bus or conductive leads of a printed circuit board.

Buffer 210 may receive an input signal labeled SYSTEM INPUT and provide gain for signal SYSTEM INPUT. Buffer 210 may receive a vertical eye movement signal from eye adjuster device 205 to shift a DC reference level of signal SYSTEM INPUT. The vertical eye movement signal may indicate a DC offset cancellation voltage to apply to substantially negate DC offset. For example, if buffer 210 includes differential input terminals, the differential input terminals may receive the vertical offset signal as a differential signal to substantially cancel DC offset present in eye adjuster system 100. Buffer 210 may be implemented as a differential or non-differential gain amplifier.

Peak detector 215 may measure peak amplitudes of a version of signal SYSTEM INPUT provided by buffer 210. Peak detector 215 may provide the peak amplitude to eye adjuster device 205. For example, peak detector 215 may measure and indicate peak amplitude based on a short time period (e.g., one or several signal cycles of the amplified signal provided by buffer 210) or by averaging peak values of the amplified signal provided by buffer 210 over a longer time period. Peak detector 215 may be implemented as a (1) zero gain buffer with a capacitor for short time period peak measurement or (2) rectifier with capacitor for averaging peak values over a longer time period.

LIA 220 may amplify the a version of signal SYSTEM INPUT provided by buffer 210 and limit an amplitude range of the resulting amplified signal. The amplitude limited signal output by LIA 220 may be referred to as signal INPUT. LIA 220 may be implemented as a limiting amplifier.

Phase adjuster 230 may delay the phase of clock signal CLK from PLL 250 based on the horizontal offset signal from eye adjuster device 205 (such delayed phase clock signal is shown as PCLK). Phase adjuster 230 may be implemented as a mixer, phase interpolator, and/or duty cycle distortion device.

Phase comparator 240 may compare phases of the clock signal PCLK and the signal INPUT. Phase comparator 240 may output comparisons between phases of signals PCLK and INPUT (e.g., lead or lag). Phase comparator 240 may output samples of the signal INPUT timed according to the signal PCLK (such samples are shown as signal SAMPLES). Phase comparator 240 may also indicate whether an illegal stage in samples of signal INPUT occurs. An illegal stage may correlate with the bit error rate for high frequency injected bit errors. Phase comparator 240 may be implemented as an Alexander (“bang-bang”) type filter. One implementation of the Alexander phase detector is described in Electronic Letters by J. D. H. Alexander in an article entitled, Clock Recovery From Random Binary Signals, Volume 11, page 541-542, October 1975.

PLL 250 may output clock signal CLK. The frequency of signal CLK may be approximately the same as that of signal INPUT. PLL 250 may adjust the phase of clock signal CLK based on phase comparisons (e.g., lead or lag) from phase comparator 240. PLL 250 may be implemented as a phase lock loop.

Eye opening detector 260 may provide an indication of the extent to which transitions of the signal INPUT are confined within expected phase regions (i.e., the “eye opening”). Eye opening detector 260 may determine the eye opening based on the clock signal CLK or, as depicted, signal PCLK. Eye opening detector 260 may be implemented using techniques described in U.S. Ser. No. 10/206,378 filed Jul. 25, 2002 (attorney docket number P14350).

Shift register 270 may store one bit of signal SAMPLES from phase comparator 240. Consecutive bit detector 280 may indicate whether two consecutive bits of signal SAMPLES match. Consecutive bit detector 280 may be implemented as an exclusive OR gate with inputs of two consecutive bits (e.g., one bit from phase comparator 240 and one bit from shift register 270).

Lock detect 290 may indicate a frequency deviation of signal CLK from a receiver system reference clock. Lock detect 290 may indicate how many parts per million the clock signal CLK from PLL 250 deviates from the reference clock. Lock detect 290 may also indicate whether reference clock and CLK are out of synchronization.

Demux 300 may convert bits from shift register 270 into a parallel byte stream (or other number of bits). Shift register 310 may store one byte of signal SAMPLES (or other number of bits). Consecutive pattern detector 320 may indicate whether two consecutive bytes (or other number of consecutive bits) are the same. Consecutive pattern detector 320 may be implemented as two sets of exclusive OR gates with outputs tied to an AND gate, where the inputs to the two sets of exclusive OR gates are two consecutive bytes (i.e., one byte from demux 300 and one byte from shift register 310). Identical byte or bit patterns can show a false locking to a noise source or a reference clock.

FEC processor 330 may indicate a bit error rate (BER) of a parallel stream from demux 300. In compliance for example with ITU-T G.975, FEC processor 330 may extract the BER from the FEC code included in a payload derived from the parallel stream. In one implementation, FEC processor 330 may provide BER information to eye adjuster device 205 using an inter-IC (I²C) compatible communication line, serial peripheral interface (SPI), or any other interface.

Based on characteristics of an input signal SYSTEM INPUT as well as signals based on signal SYSTEM INPUT, eye adjuster device 205 may provide and adjust both DC offset cancellation and horizontal sampling point of eye adjuster system 100. For example, eye adjuster device 205 may determine DC offset cancellation and horizontal sampling points by using some or all of the following inputs: (a) a peak level of an amplified signal provided by buffer 210 (that may be measured by peak detector 215); (b) the extent to which transitions of the input signal SYSTEM INPUT are confined within expected phase regions (that may be measured by eye opening detector 260); (c) illegal stages in samples of the signal SYSTEM INPUT (that may be measured by the phase comparator 240); (d) the occurrence of consecutive bit and byte patterns (or other numbers of bits) in signal SYSTEM INPUT (that may be measured by respective consecutive bit detector 280 and consecutive pattern detector 320); (e) bit error rate of the signal SYSTEM INPUT (that may be measured by the FEC processor 330); and/or (f) deviations between signal CLK and a local system reference clock (that may be measured by lock detector 290). For example, eye adjuster device 205 may adjust DC offset cancellation and/or the horizontal sampling point of receiver system 5 using an algebraic relationship based on one or more of the above signal parameters.

For example, eye adjuster device 205 may step through and adjust each signal parameter in the following manner: measure a signal parameter, adjust either or both of the horizontal and vertical offset(s) to change the signal parameter to a desired value or range, and then read the signal parameter again.

### Modifications

The drawings and the forgoing description gave examples of the present invention. The scope of the present invention however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
receiving an input signal;
providing DC offset cancellation signals based on at least one characteristic of the input signal; and
providing a sampling phase adjustment based on at least one characteristic of the input signal.

2. The method of claim 1, further comprising:
measuring a peak amplitude of the input signal, wherein at least one characteristic of the input signal comprises a peak amplitude of the input signal.

3. The method of claim 1, further comprising:
measuring an extent to which transitions of the input signal occur within confined phase regions, wherein at least one characteristic of the input signal comprises an extent to which transitions of the input signal occur within confined phase regions.

4. The method of claim 1, further comprising:
sampling the input signal using a clock signal;
detecting illegal stages in samples, wherein at least one characteristic of the input signal comprises occurrences of illegal stages.

5. The method of claim 1, further comprising sampling the input signal using a clock signal.

6. The method of claim 5, further comprising determining whether consecutive sample bits are identical, wherein at least one characteristic of the input signal comprises whether consecutive sample bits are identical.

7. The method of claim 5, further comprising determining whether consecutive sample bytes are identical, wherein at least one characteristic of the input signal comprises whether consecutive sample bytes are identical.

8. The method of claim 5, further comprising determining an extent to which the clock signal deviates from a reference clock signal, wherein at least one characteristic of the input signal comprises an extent to which the clock signal deviates from the reference clock signal.

9. The method of claim 5, further comprising determining bit error rates in the samples based on FEC coding, wherein at least one characteristic of the input signal comprises bit error rates of the samples.

10. The method of claim 1, wherein the providing DC offset cancellation signals further comprises determining the DC offset cancellation signals based on an algebraic relationship with at least one characteristic of the input signal.

11. The method of claim 1, wherein the providing a sampling phase adjustment further comprises determining the sampling phase adjustment based on an algebraic relationship with at least one characteristic of the input signal.

12. The method of claim 1, wherein the providing DC offset cancellation signals further comprises adjusting the DC offset cancellation signals based on a change in any of the at least one characteristic of the input signal.

13. The method of claim 1, wherein the providing a sampling phase adjustment further comprises adjusting the sampling phase adjustment based on a change in any of the at least one characteristic of the input signal.

14. An apparatus comprising:
at least one integrated circuit, wherein the integrated circuit is to include the capability, either alone or in combination with other integrated circuits, to
receive an input signal,
provide DC offset cancellation signals based on at least one characteristic of the input signal, and
provide a sampling phase adjustment based on at least one characteristic of the input signal.

15. The apparatus of claim 14, wherein the integrated circuit is to include the capability, either alone or in combination with other integrated circuits, to:
measure a peak amplitude of the input signal, wherein at least one characteristic of the input signal comprises a peak amplitude of the input signal.

16. The apparatus of claim 14, wherein the integrated circuit is to include the capability, either alone or in combination with other integrated circuits, to:
measure an extent to which transitions of the input signal occur within confined phase regions, wherein at least one characteristic of the input signal comprises an extent to which transitions of the input signal occur within confined phase regions.

17. The apparatus of claim 14, wherein the integrated circuit is to include the capability, either alone or in combination with other integrated circuits, to:
sample the input signal using a clock signal;
detect illegal stages in samples, wherein at least one characteristic of the input signal comprises occurrences of illegal stages.

18. The apparatus of claim 14, wherein the integrated circuit is to include the capability, either alone or in combination with other integrated circuits, to sample the input signal using a clock signal.

19. The apparatus of claim 18, wherein the integrated circuit is to include the capability, either alone or in combination with other integrated circuits, to determine whether consecutive sample bits are identical, wherein at least one characteristic of the input signal comprises whether consecutive sample bits are identical.

20. The apparatus of claim 18, wherein the integrated circuit is to include the capability, either alone or in combination with other integrated circuits, to determine whether consecutive sample bytes are identical, wherein at least one characteristic of the input signal comprises whether consecutive sample bytes are identical.

21. The apparatus of claim 18, wherein the integrated circuit is to include the capability, either alone or in combination with other integrated circuits, to determine an extent to which the clock signal deviates from a reference clock signal, wherein at least one characteristic of the input signal comprises an extent to which the clock signal deviates from the reference clock signal.

22. The apparatus of claim 18, wherein the integrated circuit is to include the capability, either alone or in combination with other integrated circuits, to determine bit error rates in the samples based on FEC coding, wherein at least one characteristic of the input signal comprises using bit error rates.

23. The apparatus of claim 14, wherein the integrated circuit to include the capability, either alone or in combination with other integrated circuits, to provide DC offset cancellation signals further includes the capability to determine the DC offset cancellation signals based on an algebraic relationship with at least one characteristic of the input signal.

24. The apparatus of claim 14, wherein the integrated circuit to include the capability, either alone or in combination with other integrated circuits, to provide a sampling phase adjustment further includes the capability to determine the sampling phase adjustment based on an algebraic relationship with at least one characteristic of the input signal.

25. The apparatus of claim 14, wherein the integrated circuit to include the capability, either alone or in combination with other integrated circuits, to provide DC offset cancellation signals further includes the capability to adjust the DC offset cancellation signals based on a change in at least one characteristic of the input signal.

26. The apparatus of claim 14, wherein the integrated circuit to include the capability, either alone or in combination with other integrated circuits, to provide a sampling phase adjustment further includes the capability to adjust the sampling phase adjustment based on a change in at least one characteristic of the input signal.

27. A system comprising:
at least one integrated circuit, wherein the integrated circuit is to the capability, either alone or in combination with other integrated circuits, to
receive an input signal,
provide DC offset cancellation signals based on at least one characteristic of the input signal,
provide a sampling phase adjustment based on at least one characteristic of the input signal, and
provide a reproduction of the input signal;
a layer two processor to receive the reproduction; and
an interface device to receive signals from the layer two processor.

28. The system of claim 27, further comprising a XAUI compatible interface to couple the layer two processor with the interface device.

29. The system of claim 27, wherein the layer two processor comprises logic to perform media access control in compliance with IEEE 802.3.

30. The system of claim 27, wherein the layer two processor comprises logic to perform optical transport network de-framing in compliance with ITU-T G.709.

31. The system of claim 27, wherein the layer two processor comprises logic to perform forward error correction processing in compliance with ITU-T G.975.

32. The system of claim 27, further comprising a switch fabric coupled to the interface device.

33. The system of claim 27, further comprising a packet processor coupled to the interface device.
